(19) United States
(12) Patent Application Publication
(10) Pub. No.: US 2017/0031918 A1
(43) Pub. Date: Feb. 2, 2017

(54) TECHNIQUES FOR GRAPH-BASED RECOMMENDATIONS

(71) Applicant: Style Hunter LLC, Miami Beach, FL (US)

(72) Inventors: Chuck SUGNET, Santa Cruz, CA (US); Barney GOVAN, Walnut Creek, CA (US); Simon PECK, San Francisco, CA (US)

(21) Appl. No.: 15/220,039

(22) Filed: Jul. 26, 2016

Related U.S. Application Data
(60) Provisional application No. 62/197,246, filed on Jul. 27, 2015.

(51) Int. Cl. G06F 17/30; G06F 9/50

(52) U.S. Cl. CPC G06F 17/3053; G06F 17/30958; G06F 9/5038; G06F 17/30867

(57) ABSTRACT

Methods, systems, and computer program products are described that enable access to resources, some of the resources being related to a degree to each other. A metric is measured that is associated with the access, and information is stored that describes the access. A data structure is generated that represents the resources, the access to the resources, and the respective degrees of relationship among the resources. Based on the data structure, an allocation priority for a resource is generated, and the resource is allocated based on the allocation priority.

### CROSS-REFERENCE TO RELATED APPLICATIONS

This application claims priority to U.S. Provisional Patent Application No. 62/197,246, currently pending, filed on Jul. 27, 2015, entitled “TECHNIQUES FOR GRAPH-BASED RECOMMENDATIONS,” original attorney docket no. “4251.003PRV,” the disclosure of which is hereby incorporated by reference in its entirety for all purposes.

### FIELD

The present disclosure generally relates to data processing systems. More specifically, the present disclosure relates to methods, systems and computer program products that provide techniques for processing event data representing the historical activity of users to generate object-scoring models, for use by a real-time scoring engine, with which user recommendations are generated.

### BACKGROUND

A recommendation system (sometimes referred to as a recommender system, or recommendation engine or platform) is a type of information filtering system that seeks to predict the preference or rating that a person would give to some item. Internet or web-based applications and services use recommendations systems to generate and provide user recommendations for a wide variety of items. For example, various online applications and services use such recommendation systems to provide user recommendations relating to: products and services, digital media and content (e.g., books, movies, music, photographs, news), people, jobs, travel destinations, and a whole variety of other items.

### DESCRIPTION OF THE DRAWINGS

Some embodiments of the inventive subject matter are illustrated herein by way of example, and not limitation, in the FIG's. of the accompanying drawings, in which:

FIG. 1 is a schematic diagram of a computer network environment including an online service that facilitates searching for, finding and recommending products, consistent with embodiments of the invention;

FIG. 2 is a schematic diagram showing an example of a graph, having vertices (nodes) and edges that correspond with various data objects, and the interactions that users have had with those objects via the online service of FIG. 1, consistent with embodiments of the invention;

FIG. 3 is a flow diagram illustrating various operations that are performed as part of a method to generate user recommendations, consistent with some embodiments;

FIGS. 4, 5 and 6 are schematic diagrams showing portions of a system architecture for an online service that facilitates searching for, finding and recommending products, consistent with embodiments of the invention; and

FIG. 7 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products that individually provide techniques by which user recommendations are generated and provided to users of an online application or service. More specifically, described herein are techniques for extracting, from one or more databases, data representing the historical interactions that users have had with various data objects via an online application or service, and from the extracted data generating a graph data structure from which data object relationships can be inferred. This graph is then used as the basis for generating one or more object scoring models, used by a real-time scoring engine, to generate user recommendations in real-time or near real-time. In the following description, for purposes of explanation, numerous specific details are set forth in order to provide a thorough understanding of the various aspects of different embodiments.

However, it will be evident to one skilled in the art that various embodiments may be practiced without each and every specific detail set forth herein.

As set forth herein, a recommendation system is described to be integrated with and operate as part of an online application or service (hereinafter referred to as a “product search service”) that facilitates searching for, finding, and recommending products, questions (referred to as “Hunts”), answers, tags, stores, and people to follow. By way of example, various aspects of such a service are described in greater detail in Provisional Application No's. 62/053,037 (“Metadata-assisted Visual Search Engine”) and 62/150,529 (“Metadata and Photo Recognition-Assisted Visual Search”). Consistent with some embodiments, the product search service receives from a user certain data (e.g., a picture with or without descriptive tag(s), textual description, etc.) relating to an item or product that the user is potentially interested in purchasing, or for which the user would like to obtain additional information (e.g., price, alternative color and style options, etc.). This data received from the user becomes part of a user's inquiry or search, which, for purposes of the product search service, is a special data object and referred to herein as a “Hunt.” The user-submitted data relating to the item of interest (i.e., “the Hunt”) is then presented to other users, and these other users are provided an opportunity to submit or provide information that might satisfy the Hunt. For example, a first user may post a picture (e.g., a digital photograph) of a woman wearing a red skirt and a blue blouse, along with a tag (e.g., “#redskirt”) to indicate the user's interest in the red skirt shown in the photograph. The first user's search or Hunt will then be displayed to other users.

Another user may then be prompted to provide information (e.g., the URL of an online store) relating to where the red skirt can be purchased. In this way, a community of users help one another by providing information that satisfies or solves other users' product searches or Hunts.

If the user who has posted a search or Hunt is satisfied with another user's proposed solution (e.g., the URL of an online store where a product can be purchased), the user may indicate his or her satisfaction by up-voting the proposed solution, or marking the proposed solution as a perfect solution. A proposed solution to a search or Hunt (referred to herein as a “Find” or “Product”) is generally said to “solve” the search or Hunt, and will typically be associated with a location (e.g., URL or other similar information) at which an item can be purchased, and therefore may include other information, such as a price, a button or link to the specific website or online store from which the product can be purchased, and so forth. Accordingly, product searches or Hunts may be designated as either being solved (e.g., associated with a proposed solution), marked perfect (e.g., have a proposed solution that has been confirmed as a perfect solution by the user who posted the search or Hunt), and unsolved (e.g., have no proposed solutions). For those product searches or Hunts that have been solved, there will be information about where a product can be purchased. As such, users may elect to simply browse or search for products by browsing and/or searching solved Hunts. While some users may use the service to search for products to buy, other users may be more interested in recommending products and providing information that will satisfy others' searches or Hunts. Accordingly, some users may elect to browse or search for unsolved Hunts, with a view to providing information to solve those searches or Hunts. Because different users are engaging with the product search service with different goals and objectives, different types of user recommendations may be generated and provided to the users, based on an individual user's prior activity on the site, as well as historical user activity in the aggregate.

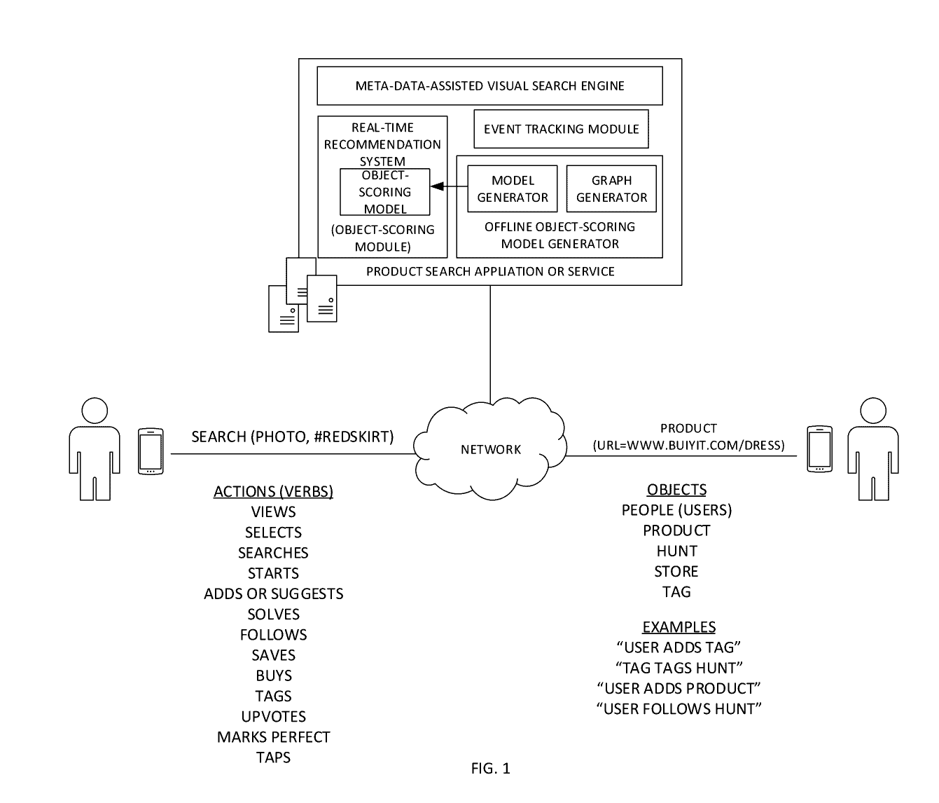

Referring now to FIG. 1, an example computer network environment is shown to include a product search service, consistent with embodiments of the invention. As shown in FIG. 1, via the product search service, a user can take a variety of actions with respect to various objects or elements of the search service. Consistent with some embodiments, an event tracking module is used to identify when a user has taken a particular action, and with which object. This event information is then stored in a database for subsequent analysis and use in generating a graph-like data structure, from which one or more object-scoring models can be generated for use in making user recommendations.

As illustrated in FIG. 1, the product search service may provide functionality enabling a user to search for and/or browse other users' Hunts (e.g., product searches, solved or unsolved), people (e.g., other users), and/or Products. In addition, a user may search by tag, title or textual description for Hunts and/or Products that have been tagged by other users. For example, a user may initiate a search with a hash tag, “#redskirt”, to view Hunts and/or Products that other users have tagged with the tag, #redskirt.

If a first user is interested in an unsolved Hunt that another user has posted, the first user can “follow” the unsolved Hunt, and thus receive notifications when other users submit solutions (e.g., Products) to the unsolved Hunt. In addition, users may choose to follow other users to receive notifications when those users post Hunts or Products. Accordingly, as shown in FIG. 1 and consistent with some embodiments, the user actions that are possible, and which the system tracks include, but are not necessarily limited to:

Views

Selects

Searches (e.g., existing Hunts, Products, by Tag)

Starts (e.g., Initiate or Post a Hunt)

Adds or Suggest s(e.g., a Product, or Tag)

Solves

Follows

Saves

Buys

Tags

Up-votes

Down-votes

Marks Perfect

Taps

Consistent with some embodiments, the data objects or application elements on which the user actions can be performed include, but are not necessarily limited to:

People (users)

Hunts (e.g., product searches)

Products

Tags

Stores

Of course, some actions may be limited to being performed with some subset of the objects, such that those actions can only be taken with respect to those objects in the subset. For instance, a user may perform an “add” action to add a new tag, or a “start” action to start a new Hunt, but neither of these actions would apply to another user. Similarly, a user may be able to tag a Product or a Hunt, but not another tag, and not another user.

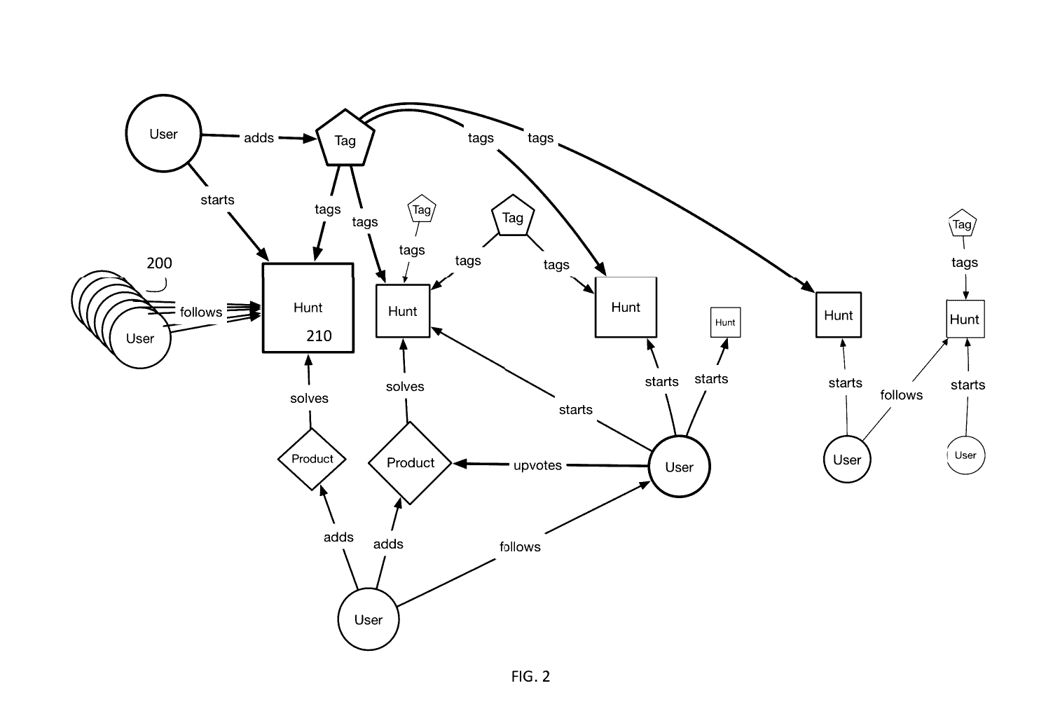

FIG. 2 is a schematic diagram showing an example of a graph, having vertices (or nodes) and edges that correspond with various actions that users have taken with different data objects via the product search service of FIG. 1, consistent with embodiments of the invention. For example, as illustrated in FIG. 2, the graph shows that several users 200 are following the Hunt with reference number 210. For purposes of the illustration in FIG. 2, the size of the node is meant to convey the relative number of actions users have taken with respect to the particular data object represented by the node. So, for instance, the Hunt with reference number 210 is shown in FIG. 2 as being larger than other Hunts, because more users are following the Hunt with reference number 210.

From the graph shown in FIG. 2, the various relationships between objects become apparent. For example, the most commonly used or interacted with objects are readily apparent, as is the relationship between these objects. While the graph is shown in FIG. 2 to be a directed graph, in actual implementation, the graph may be implemented or represented with a particular data structure, such as an adjacency matrix, where each coefficient or element of the matrix will represent a unique data object, and its value will represent the number of interactions users have had with the object. As many objects will be associated with a limited number of interactions, the resulting matrix is likely to be sparse, and a shrinkage or data reduction operation can be performed to ensure that only the most relevant data is represented in a reduced matrix.

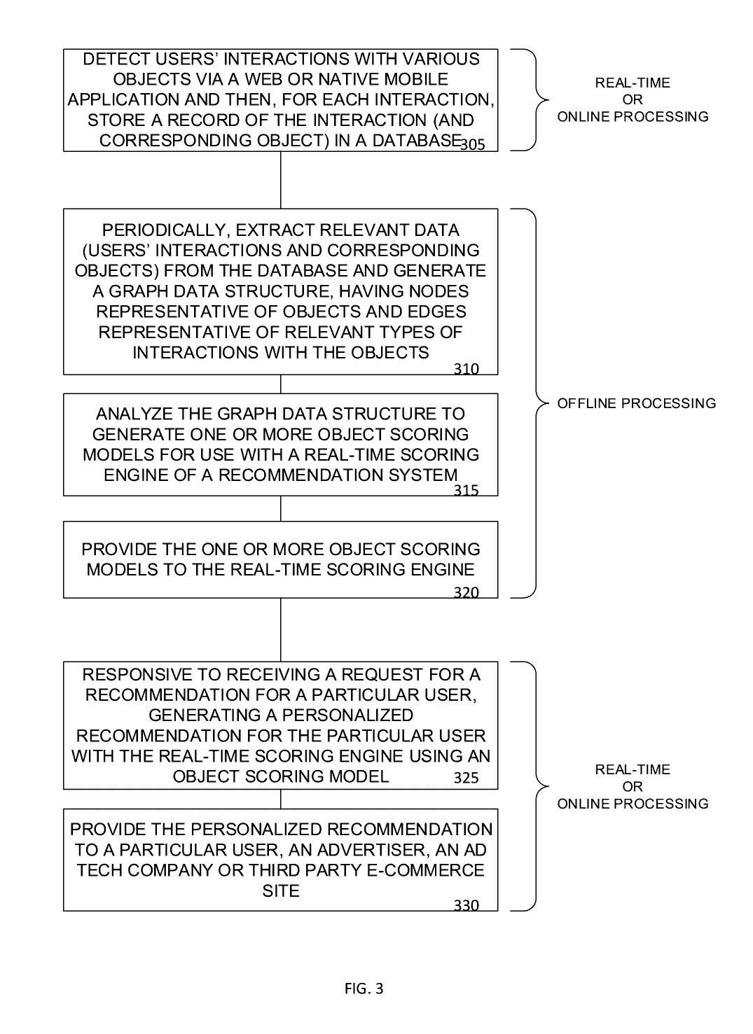

FIG. 3 is a flow diagram illustrating various operations that are performed as part of a method to generate user recommendations, consistent with some embodiments. The method operations performed in FIG. 3 can be thought of as taking place in multiple phases—some online in real-time (e.g., responsive to users' requests), and some offline (e.g., in the background). For example, during a first phase (reference number 305), as users interact with the product search service, all of the actions that the users are taking, as well as the data objects on which the actions are taken, are detected and stored either as event tracking data or in a relational database. For instance, users login to the product search service and have various interactions with the different data objects. A user may post a new Hunt, follow a Hunt, follow another user or tag, post a solution to a Hunt, and so forth. During the course of a particular time period (e.g., a day, a week, a month) significant volume of these types of interactions will be detected, and for each interaction, a database record will be generated to store the event data. For a given event, the data record will include fields for tracking certain aspects of the event to include (but not be limited by): information identifying the user or object that performed the event, information indicating the exact time the event occurred, the specific action taken, and the specific data object on which the action was performed.

Periodically, an offline process is performed to generate one or more object scoring models that can be used by a real-time object-scoring engine to generate user recommendations. Referring again to FIG. 3, at method operation 310 a data gathering or data extraction process is executed to obtain all of the event data that has been generated over a particular time period—for example, the last two weeks. The time period selected is of course a design or implementation detail and may vary from one embodiment to the next. In general, the time period selected should be such that the amount of data involved in generating the graph is such that meaningful recommendations can be achieved. With some embodiments, the data extraction process may select only event data that is desired for generating a particular type of recommendation. For example, in some instances, only event data pertaining to some subset of data objects may be extracted and used in generating the graph.

In any event, at method operation 315, a graph-like data structure (e.g., an adjacency matrix) is compiled or generated from the extracted user event data.

Generally, the matrix can be characterized as having coefficients (or elements) representative of the unique data objects (e.g., Hunts, Products, Users, Tags, etc.), and values representative of the number of user interactions that have been taken during the relevant time period on the particular object represented by the coefficient. For instance, referring to the graph in FIG. 2, one might expect a coefficient representing the Hunt with reference number 210 to have a greater value than the coefficients representing other Hunts in a matrix representative of the graph shown in FIG. 2. In any case, as the matrix is likely to be large (on the order of one million by one million) and rather sparse, the matrix may be reduced or shrunk, for example, by performing one or more matrix operations to eliminate coefficients that do not exceed some threshold. When eliminating coefficients, the remaining coefficients will need to be adjusted downward accordingly. With some embodiments, the graph may be reduced to include only some predetermined number of most significant data objects (coefficients)—for example, the top one million, determined by the top hundred eigenvectors.

Finally, at operation 320, the eigenvector representation of the matrix is written to a memory location where it can be accessed and used by a real-time object scoring engine.

Accordingly, at method operation 325, in response to a user making a request of the product search service, the real-time object-scoring engine receives a request to provide the user with a set of recommended data objects. Using the scoring model generated from the graph, the real-time object-scoring engine generates a ranked list of data objects for the user, for example, by calculating a measure of distance between a vector representing an object and the various vectors of the scoring model. With some embodiments, the cosine of the angle or cosine distance is used as the measure of distance to rank the objects.

With some embodiments, because the object scoring model is a high dimensional matrix, locality-sensitive hashing may be used to reduce the dimensionality of the data, so that similar data objects map to the same “buckets” with high probability (the number of buckets being much smaller than the total number of objects in the universe of possible objects to rank and recommend.)

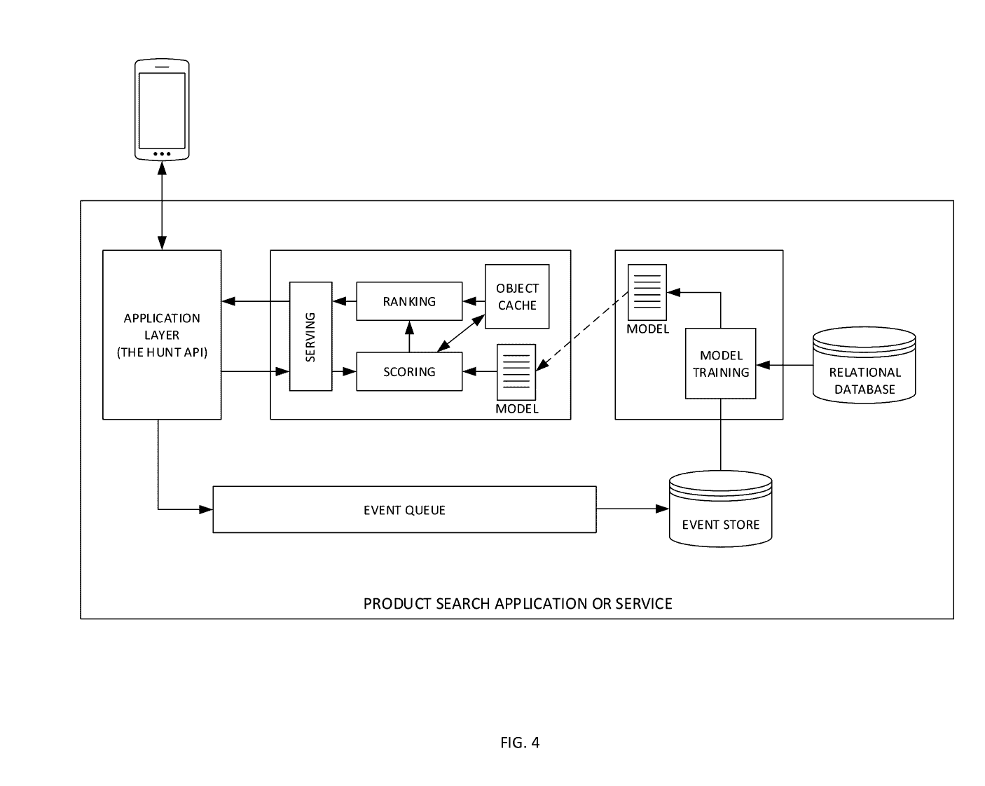

FIG's. 4, 5 and 6 are schematic diagrams showing portions of a system architecture for an online service that facilitates searching for, finding and recommending products and other data objects, consistent with embodiments of the invention. As illustrated in FIG. 4, a client-computing device interacts with the product search application or service, for example, using well-known Internet communication protocols (e.g., HTTP). Of particular relevance with respect to the innovative subject matter set forth herein, the product search service includes both a real-time object-scoring engine for generating real-time recommendations, and an offline object-scoring model generator for generating and training object scoring models for use by the real-time object-scoring engine, when generating user recommendations. The individual components—that is, the real-time object-scoring module and the offline object-scoring model generator—are described separately below in connection with FIG's. 5 and 6 respectively.

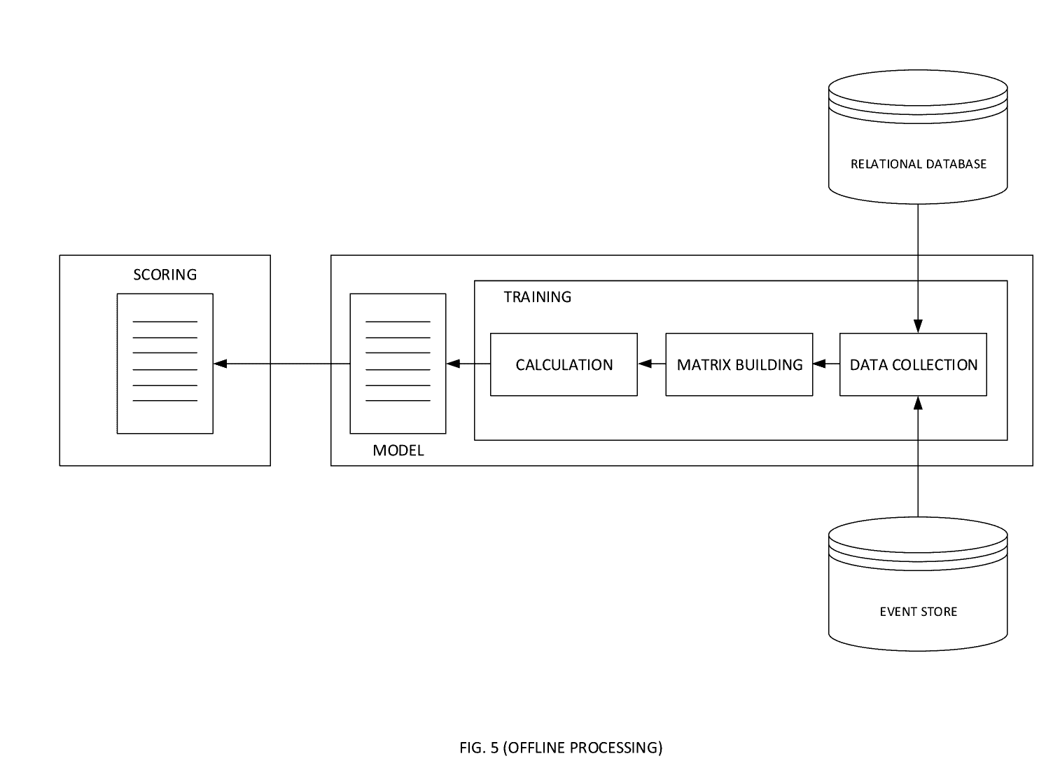

FIG. 5 is a schematic diagram illustrating the operations performed by one example of an offline object-scoring model generator, consistent with some embodiments of the invention. Consistent with some embodiments, a Data Collection process requests and obtains data from one or more accessible databases. Specifically, the data obtained is data representing the users' activity or interactions with respect to various data objects or application elements of the product search service over a given period of time—for example, the last two weeks. The event data may represent a particular type of action (e.g., follow, save, buy, start, etc.) that a data object performed between two particular data objects (e.g., a user [object] adds [action] a product [object]). This data may, with some embodiments, be written to one or more data files in a compressed JSON (JavaScript Object notation) format.

Next, a graph or Matrix Building process loads the extracted event data (e.g., CSV files) into local storage and builds a sparse representation of the graph (e.g., adjacency matrix). In addition to generating the graph, the Matrix Building process writes a dictionary mapping the matrix indices to the data object identifiers. Next, a Calculation module or process loads the sparse matrix and the data object dictionary, calculates the first N eigenvectors of the matrix, applies a shrinkage method to trim off the vast majority near-zero eigenvector parameters, and creates from the original dictionary a modified dictionary for the reduced eigenvectors, such that the modified dictionary maps only those objects that continue to be included in the reduced eigenvectors. Consistent with some embodiments, the reduced eigenvectors and the modified dictionary are included in a JSON file (e.g., Model in FIG. 5), which is loaded into memory for accessing by the real-time object-scoring engine, and for use in generating real-time recommendations.

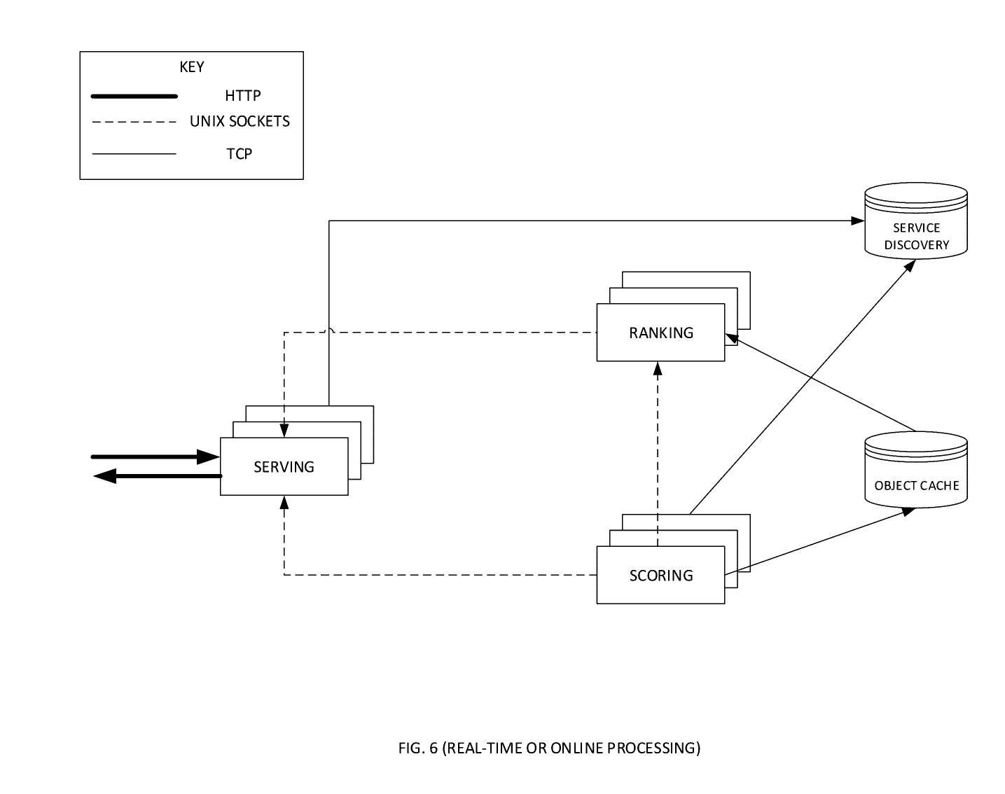

FIG. 6 is a schematic diagram illustrating the modules and related processes included as part of one example of a real-time object-scoring engine for generating user recommendations, consistent with some embodiments of the invention. As illustrated in FIG. 6, an HTTP request, including a request for a user recommendation, is received by the Serving process, which sets a timer for responding. The request generally will include information identifying a data object (e.g., User, Hunt, Product, etc.) for which the recommendation is to be generated. The Serving process then performs a look-up operation to identify the location of a relevant object-scoring process within Service Discovery—a centralized service for maintaining configuration information, naming, providing distributed synchronization, and providing group services.

Next, the Serving process routes the request for the user recommendation via a messaging protocol (e.g., Unix Sockets in FIG. 6) to the appropriate object-scoring process (Scoring process in FIG. 6), including with the request the appropriate call-back address. The Scoring process scores the requesting object (that is, the object identified in the initial recommendation request), and writes the object score to the object cache (Object Cache in FIG. 6). Next, the Scoring process looks up the location of a ranking process in Service Discovery. The Scoring process then routes the object score, with the Serving process call-back address, to the Ranking process.

The Ranking process gathers object data from the object cache and determines the best “matching” objects, using the object-scoring model (generated by the offline object-scoring model generator). The Ranking process routes the best “matching” objects back to the Serving process. The Serving process checks the timer, and it has not expired, the Serving process stops the time and returns the recommended data objects to the client.

Using techniques described herein, a variety of user recommendations can be generated. Consider the following examples. Given that a user has selected or viewed a particular Hunt, the recommendation system may generate recommendations concerning other Hunts, or other Products, in which the user might be interested. Similarly, if a first user chooses to follow another user, the recommendation system may recommend other users that might be of interest to the first user. If a user chooses to follow a particular tag, the recommendation system might generate recommendations relating to other tags, Hunts or Products. A recommendation for a user may be generated to recommend other users to follow, based on tags or hunts that the user has followed, or objects that the user has saved or upvoted.

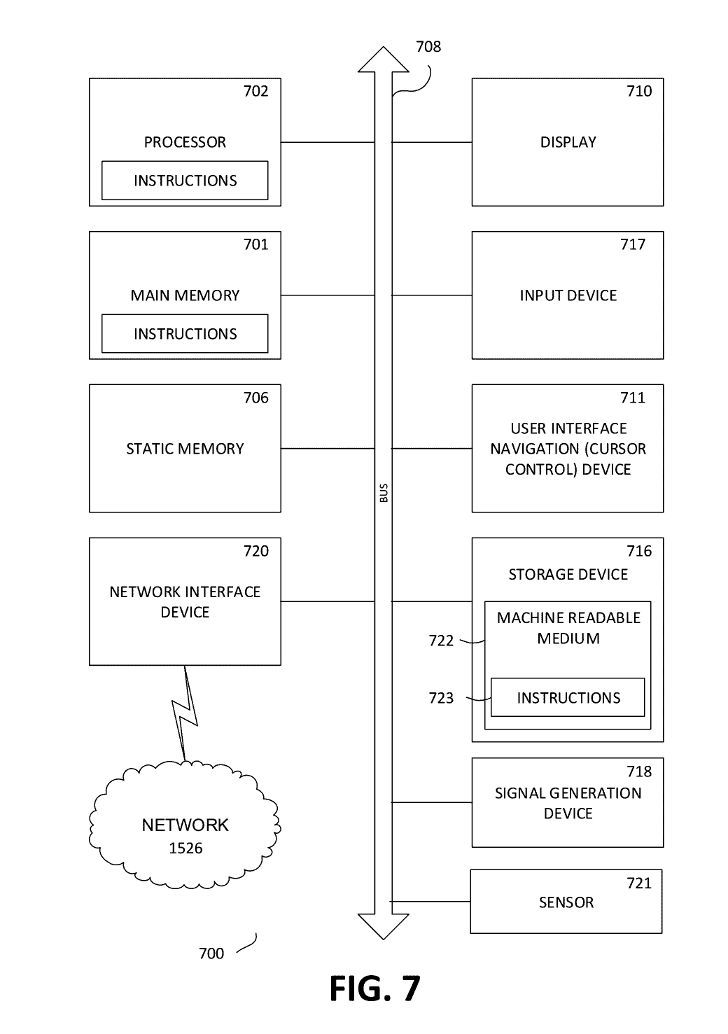

FIG. 7 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 701 and a static memory 706, which communicate with each other via a bus 708. The computer system 700 may further include a display unit 710, an alphanumeric input device 717 (e.g., a keyboard), and a user interface (UI) navigation device 711 (e.g., a mouse). In one embodiment, the display, input device and cursor control device are a touch screen display. The computer 700 may additionally include a storage device 716 (e.g., drive unit), a signal generation device 718 (e.g., a speaker), a network interface device 720, and one or more sensors 721, such as a global positioning system sensor, compass, accelerometer, or other sensor.

The drive unit 716 includes a machine-readable medium 722 on which is stored one or more sets of instructions and data structures (e.g., software 723) embodying or utilized by any one or more of the methodologies or functions described herein. The software 723 may also reside, completely or at least partially, within the main memory 701 and/or within the processor 702 during execution thereof by the computer system 700, the main memory 701 and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies described herein, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 723 may further be transmitted or received over a communications network 726 using a transmission medium via the network interface device 720 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks).

The term “transmission medium” shall be taken to include any intangible medium that is capable of storing, encoding or carrying instructions for execution by the machine, and includes digital or analog communications signals or other intangible medium tofacilitate communication of such software.

What is claimed is:

1. A method of allocating resources, comprising:
enabling access to one or more resources of a plurality of resources, some of the plurality of resources being related to a degree to others of the plurality of resources;
measuring a metric associated with access to each of the one or more resources of the plurality of resources;
storing information describing the access of each of the one or more resources of the plurality of resources, the information being stored along with the respective metric associated with the access;
generating a data structure representing:
the plurality of resources,
the access to the one or more resources of the plurality of resources, and
respective degrees of relationship among the plurality of resources;
generating, based on the data structure, an allocation priority for a resource of the plurality of resources represented in the data structure; and
allocating the resource based on the allocation priority of the resource.

2. The method of claim 1, wherein the generating of the allocation priority for the resource comprises:
analyzing one or more of:
the access of the resource,
the respective metrics associated with the access,
access to others of the plurality of resources,
generated allocation priorities for others of the plurality of resources,
degrees of relationship between the resource and others of the plurality of resources.

3. The method of claim 1, further comprising updating the data structure to include additional resources, additional relationships among resources, additional access with respective metrics.

4. The method of claim 1, wherein the generating of the data structure is performed during off-peak computing hours.

5. The method of claim 1, further comprising:
receiving a score associated with the allocation of the resource; and
generating the data structure further representing the score,
wherein generating of additional allocation priorities for resources represented in by the data structure are further based on the score.

6. The method of claim 1, wherein the data structure is simplified by grouping resources based on a characteristic.

7. The method of claim 1,
wherein access to the one or more resources is enabled for a plurality of network nodes, wherein the allocation priority generated for resources in the data structure is generated for each of the plurality of network nodes, and
wherein a resource is allocated to each of the plurality of network nodes based on a respective allocation priority assigned to the resource for the respective network nodes.

8. A computer program product comprising a tangible computer readable storage medium storing a plurality of instructions for controlling a computer system, the instructions comprising:
enable access to one or more resources of a plurality of resources, some of the plurality of resources being related to a degree to others of the plurality of resources;
measure a metric associated with access to each of the one or more resources of the plurality of resources;
store information describing the access of each of the one or more resources of the plurality of resources, the information being stored along with the respective metric associated with the access;
generate a data structure representing:
the plurality of resources,
the access to the one or more resources of the plurality of resources, and
respective degrees of relationship among the plurality of resources;
generate, based on the data structure, an allocation priority for a resource of the plurality of resources represented in the data structure; and
allocate the resource based on the allocation priority of the resource.

9. The computer program product of claim 8, wherein the generating of the allocation priority for the resource comprises:
analyzing one or more of:
the access of the resource,
the respective metrics associated with the access,
access to others of the plurality of resources,
generated allocation priorities for others of the plurality of resources, degrees of relationship between the resource and others of the plurality of resources.

10. The computer program product of claim 8, the instructions further comprising updating the data structure to include additional resources, additional relationships among resources, additional access with respective metrics.

11. The computer program product of claim 8, wherein the generating of the data structure is performed during off-peak computing hours.

12. The method of claim 1, further comprising:
receiving a score associated with the allocation of the resource; and
generating the data structure further representing the score,
wherein generating of additional allocation priorities for resources represented in by the data structure are further based on the score.

13. The computer program product of claim 8, wherein the data structure is simplified by grouping resources based on a characteristic.

14. The computer program product of claim 8,
wherein access to the one or more resources is enabled for a plurality of network nodes, wherein the allocation priority generated for resources in the data structure is generated for each of the plurality of network nodes, and
wherein a resource is allocated to each of the plurality of network nodes based on a respective allocation priority assigned to the resource for the respective network nodes.

15. A system for allocating resources, the system comprising:
a processor;
a memory, having instructions stored thereon, that, when executed by the processor, configure the processor to perform operations, the operations comprising:
enabling access to one or more resources of a plurality of resources, some of the plurality of resources being related to a degree to others of the plurality of resources;
measuring a metric associated with access to each of the one or more resources of the plurality of resources;
storing information describing the access of each of the one or more resources of the plurality of resources, the information being stored along with the respective metric associated with the access;
generating a data structure representing:
the plurality of resources,
the access to the one or more resources of the plurality of resources, and
respective degrees of relationship among the plurality of resources;
generating, based on the data structure, an allocation priority for a resource of the plurality of resources represented in the data structure; and
allocating the resource based on the allocation priority of the resource.

16. The system of claim 15, wherein the generating of the allocation priority for the resource comprises:
analyzing one or more of:
the access of the resource,
the respective metrics associated with the access,
access to others of the plurality of resources,
generated allocation priorities for others of the plurality of resources,
degrees of relationship between the resource and others of the plurality of resources.

17. The system of claim 15, the instructions further comprising updating the data structure to include additional resources, additional relationships among resources, additional access with respective metrics.

18. The system of claim 15, wherein the generating of the data structure is performed during off-peak computing hours.

19. The system of claim 15, further comprising:
receiving a score associated with the allocation of the resource; and
generating the data structure further representing the score,
wherein generating of additional allocation priorities for resources represented in by the data structure are further based on the score.

20. The system of claim 15,
wherein access to the one or more resources is enabled for a plurality of network nodes, wherein the allocation priority generated for resources in the data structure is generated for each of the plurality of network nodes, and
wherein a resource is allocated to each of the plurality of network nodes based on a respective allocation priority assigned to the resource for the respective network nodes.
